(19) United States
(12) Patent Application Publication
(10) Pub. No.: US 2005/0187861 A1
(43) Pub. Date: Aug. 25, 2005

(54) Mortgage prepayment and record-keeping system

(76) Inventor: George A. Downey, Weymouth, MA (US)

Correspondence Address: FISH & RICHARDSON PC, 225 FRANKLIN ST, BOSTON, MA, 02110, US

(21) Appl. No.: 11/030,212

(22) Filed: Jan. 6, 2005

Related U.S. Application Data
(60) Provisional application No. 60/534,535, filed on Jan. 6, 2004.

(51) Int. Cl. G06F 17/60

(52) U.S. Cl. 705/38

(57) ABSTRACT

A method for mortgage prepayment and record-keeping including the steps of: making required monthly mortgage payment, selecting a prepayment amount, making a prepayment in the selected amount, and completing a register of payments and savings.

### TECHNICAL FIELD

This application claims benefit from U.S. Provisional Patent Application No. 60/534,535, filed Jan. 6, 2004, now abandoned, the complete disclosure of which is incorporated herein by reference.

This document relates to a method for mortgage prepayment and record keeping.

### BACKGROUND

Over the term of a home mortgage, interest payments can often total several times the purchase price of the home. Payments in advance, made against loan principal, can shorten the term of the loan, and also reduce the total amount of interest required to be paid. Most home mortgages permit such advance payments.

### SUMMARY

According to one implementation, a method for mortgage prepayment and record-keeping comprises making a required monthly mortgage payment, selecting a prepayment amount, making a prepayment in the selected amount, and completing a register of payments and savings.

Preferred embodiments of the method may include one or more of the following additional steps: selecting a prepayment amount equal to one or more present and/or future scheduled principal payments from an amortization schedule; selecting a prepayment amount equal to a sum of two or more present and/or future scheduled principal payments; and/or completing a loan prepayment note to accompany the prepayment.

The details of one or more implementations are set forth in the accompanying drawings and the description below. Other features, objects, and advantages will be apparent from the description and drawings, and from the claims.

### DESCRIPTION OF DRAWINGS

FIG. 1 is an example of a payment/benefit register;

FIG. 2 is an example of a completed payment/benefit register;

FIG. 3 is an example of a loan prepayment entry to a payment/benefit register;

FIG. 4 is an example of a loan prepayment notice form.

FIG. 5 is an example of a completed loan prepayment notice form.

FIG. 6 is a table of projected savings comparisons.

Like reference symbols in the various drawings indicate like elements.

### DETAILED DESCRIPTION

A customized mortgage payment record system is custom prepared specifically for each mortgage. The system is designed to illustrate the benefits that proper loan principal prepayment will create, and to provide a simple but comprehensive record keeping system to document progress, and to assure compliance by the lender with the custom plan. The system:
1. provides complete control to determine when and how many principal prepayments are made;
2. reduces interest costs to save money;
3. builds home equity faster;
4. pays off a mortgage sooner to achieve debt free home ownership;
5. provides a complete accounting system to track progress, verify the lender's compliance, and provide the necessary documentation to detect and resolve lender servicing errors should they occur; and
6. helps eliminate the need for private mortgage insurance (PMI) sooner.

The system is designed for financial reality in a time of sudden and dramatic reversals of the economy and the real estate markets that have significantly altered personal prospects for financial security. For most, the accumulation of debt and the loss of home value has become one of the most threatening aspects of this new reality.

Prepaying loan principal is an old idea that has taken on new value. For those who desire to take control of their financial future and become debt free, it is the most effective and efficient financial strategy available to achieve that goal, build net worth, and establish permanent financial independence.

The mortgage industry has also changed in recent years. One effect of this change has been the selling and transferring of mortgage loans and servicing. Today, it is not uncommon for a mortgage to be sold and resold multiple times to different loan service companies. Moreover, with the great variety of mortgage programs available now the servicing function has become increasingly more complex. Each time the servicing of a loan changes, the probability of record keeping errors increase. If loan principal prepayments are not properly accounted for by the servicing entity, the benefits counted on could be partially or completely lost.

Although the process of prepaying can be simple, it must be done correctly to ensure success and avoid future servicing errors and losses. The correct way includes:
1. issuing proper written notice to the lender;
2. making a separate payment for the principal prepayment; and
3. maintaining adequate and accurate records to track progress, document activity, and to verify that the lender has correctly applied each prepayment to achieve the intended savings.

The Mortgage Miser system permits simple and confident implementation of the prepayment program. It has been carefully designed for ease of use to provide:
1. Control, to enable the mortgagee, at all times, to know the exact status of the loan, the current and cumulative costs and savings; and whether the lender has properly applied the submitted payments.
2. Flexibility consistent with the loan agreement, to allows the mortgagee to make principal prepayments when he or she chooses. Each month, after making the required minimum monthly payment, the mortgagee decides how many principal prepayments, if any, to make.
3. Confidence, to provides assurance that mortgage records are correct and that proper procedures have been followed to obligate the lender to follow the instructions of the mortgagee. Moreover, the mortgagee is provides with the records necessary to back up any discrepancy.

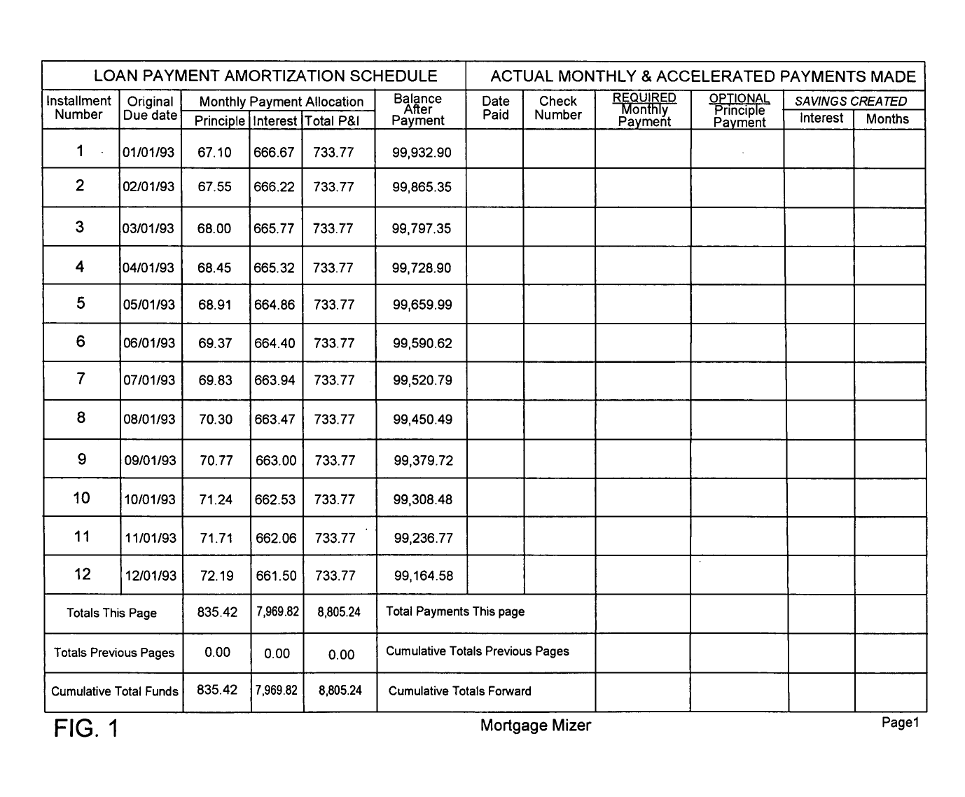

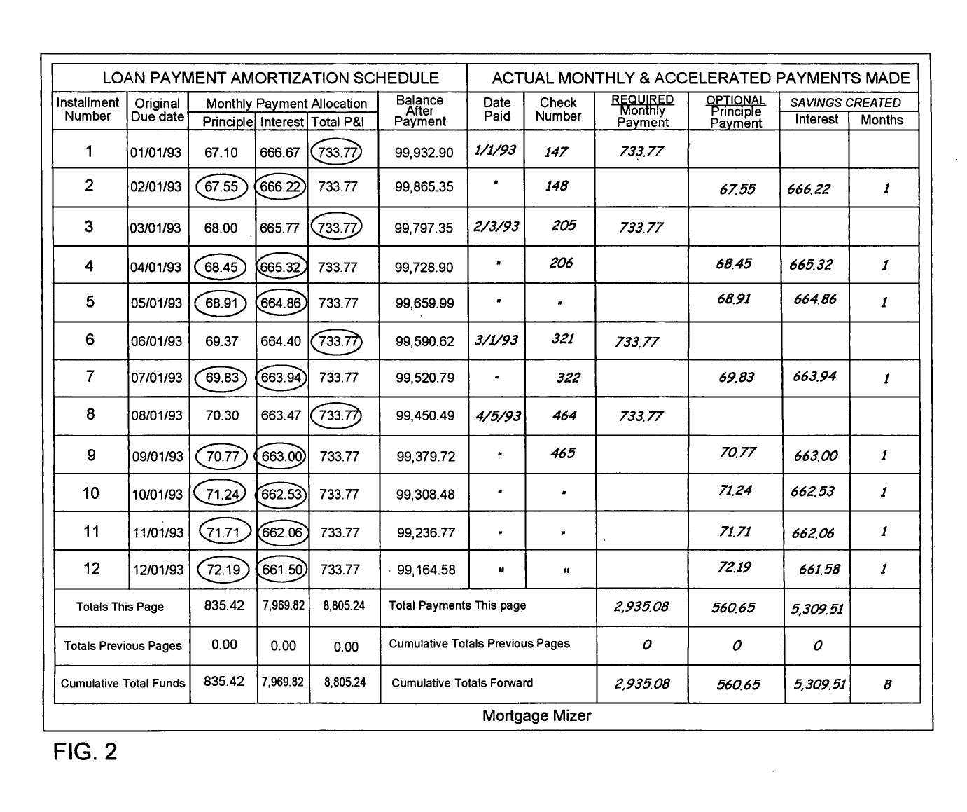

The key to the Mortgager Miser system is the Payment/Benefit Register prepared for the specific terms of each loan. An example of a typical register appears in FIG. 1. An example of a completed register appears in FIG. 2.

The loan payments required by a loan documents are shown in the loan payment amortization schedule on the left side of the register. Each page includes twelve payments of this schedule, which would depict the results of one year of payments if no prepayments were made. Each payment is broken down to show the original due date, the principal and interest portions, the total principal and interest payment due, and the balance of the loan after that payment has been made.

The right side of the register shows the actual monthly and accelerated payments made. Each month, after the required (regular) monthly payment is made and recorded, a decision is made as to how many, if any, principal prepayments are to be made in addition to the required payment. The precise amount of this optional principal prepayment is determined by adding up the principal amounts only of succeeding payments and preparing a separate payment for that precise amount. The date, check number, and principal payment amounts are then recorded along with the amount of interest saved and the number of months eliminated from the life of the loan.

Each time the principal amount of a future monthly payment is made in advance, the payoff time of the loan is reduced by one month, and the entire amount of interest associated with that specific payment is eliminated. The amount of this interest savings has been pre-calculated in the register. Page totals of each completed page then provide a running summary of the cumulative payments made and the total savings created.

By adhering to this system, the mortgagee always knows the current and cumulative payments and benefits, and the exact remaining loan balance and term. It is then a simple matter of comparing the lender and mortgagee payment history and loan balance records to confirm that payments have been properly entered. If not, and all other loan requirements have been met, the Mortgage Miser records and the mortgagee's cancelled checks will enable a proper presentation for requesting an appropriate correction.

Principal prepayment procedures that do not precisely follow the original loan amortization schedule require that the entire loan be recalculated after each payment is made in order to maintain proper records. As a result, the practice of making prepayments of irregular or random amounts is not advised. Rather, by following this system, as designed, the mortgagee can be confident of complete control while maximizing savings and minimizing costs.

Using the Mortgage Miser system is easy. By following the few simple instructions below, a mortgagee is able to achieve the incredible savings available through mortgage prepayment.
1. Before beginning, the account should be current. Principal prepayments may only be made after each required monthly payment has been made. Some lenders may require prepayments to be received by the tenth day (after the due date) to ensure being credited in the month received. Otherwise, the principal prepayment may be held and applied the following month.
2. Determine where the mortgage is in the payment schedule. Follow the instructions included with the customized Payment/Benefit Register sheets, and make the initial adjustment, if necessary, to align the record balance with that of the lender at the outset.

To make payments, simply record all required monthly payments and optional principal prepayments in the personalized Payment/Benefit Register each month in the following manner.
1. identify the correct payment number, then make the required (regular) monthly payment in the same manner as normal. Record this payment in the Payment/Benefit Register by simply drawing a circle around the intended payment (total principal and interest) in the amortization schedule. Then, to the right, enter the date, check number, and the amount under the Required Monthly Payment column.

Note that if additional payments are made each month to an escrow account for taxes, insurance, or other items, the total required monthly payment will be greater than the total principal and interest (P&I) payment shown in the-Amortization Schedule. It is recommended that the total amount of the check submitted be recorded. The difference will then represent the amount of escrow paid each month. This information may be helpful later in documenting escrow payments and resolving potential escrow accounting errors.

Determine how much to prepay in addition to the required monthly payment. There is complete freedom to make none, one, or as many prepayments as desired. Then, total the principal portion only of future payments from the Amortization Schedule to arrive at an amount close to the intended amount.

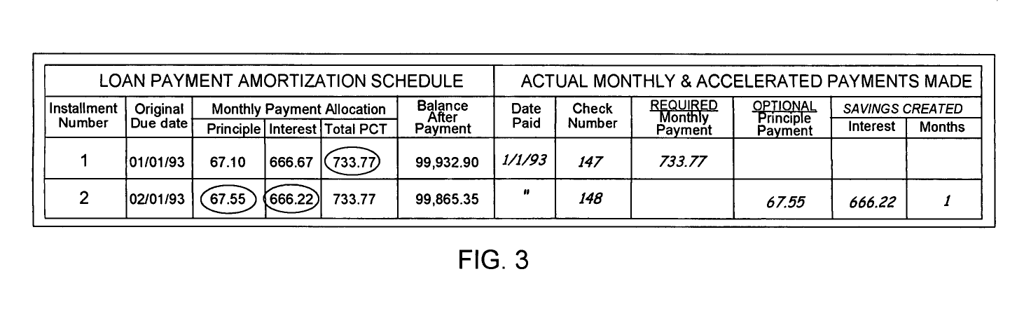

Write a separate check for this exact total, and mark the loan number or account number on the check with the notation “Principal Prepayment.” Make a record in the Payment/Benefit Register by, again, drawing a circle around both the principal and interest portions of each intended prepayment, then entered the circled principal amount to the right under the Optional Principal Payment column, and enter the circled interest amount to the right under the Interest Saved column, as shown in FIG. 3. Lastly, enter a “1” (one) under the Months Saved column for each prepayment made, to record that one month has been eliminated from the life of the loan.

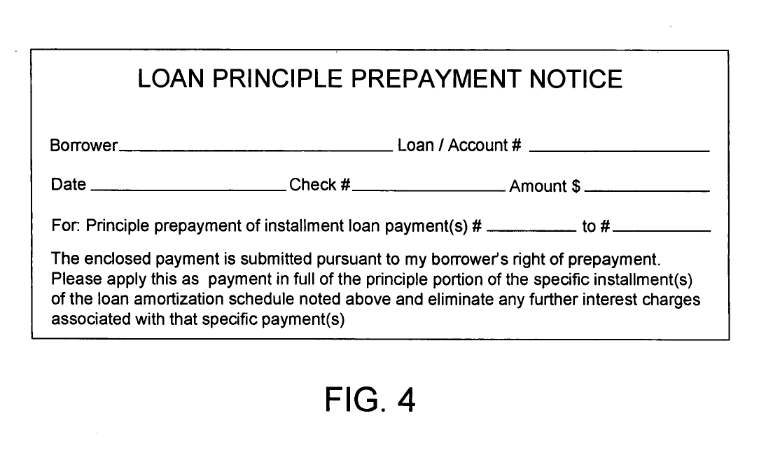

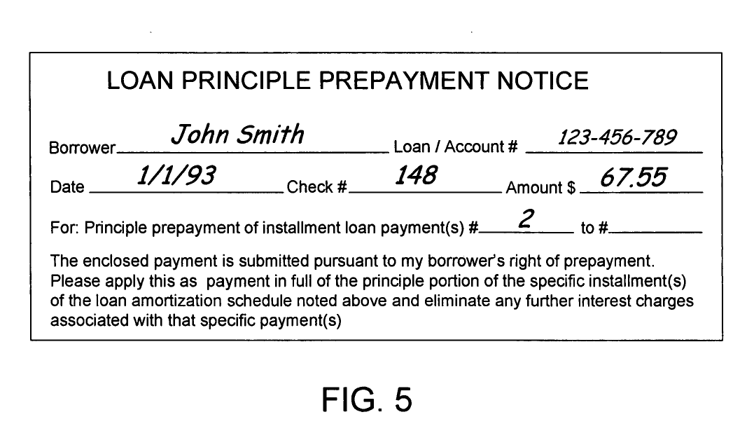

Referring next to FIGS. 4 and 5, complete a Loan Principal Prepayment Notice. These special coupon style notices may be prepared in two-part carbonless sets to fulfill requirements for adequate written notice to the lender, and to provide the mortgagee with proper documentation to support each prepayment. Once all items are completed clearly, the top portion can be torn off, a check attached, and both forwarded to the lender along with the required monthly payment. For convenience, the system may include a durable plastic sheet protector to provide a hard writing surface to ensure clear copies and to protect the underlying forms.

As each page of the Payment/Benefit Register is filled, the total of each column should be entered to provide Page and Cumulative Totals of all payments and savings. Lastly, the “Cumulative Totals Forward” should be carried forward to the next page and entered in the second line from the bottom entitled Cumulative Payments Previous Pages.

Now, at a single glance, the mortgagee will always know the exact loan balance, what has been paid, how much interest expense has been saved, and how many months or years have been eliminated from the life of the loan.

FIG. 2 is an example of a completed first page of the Payment/Benefit Register for a $100,000, 8%, 30-year mortgage loan. Notice the simplicity of the system, the flexibility in making variable numbers of prepayments, and the savings of $5,309.51 created from a total investment of $560.65 in prepaid mortgage. What's more, eight months have been eliminated from the life of the mortgage after only four months of regular payments.

The system provides an opportunity to eliminate significant amounts of interest costs, build net worth, and achieve the goal of debt-free home ownership is available, but if the mortgagee firmly establishes that goal and works consistently each month to achieve it.

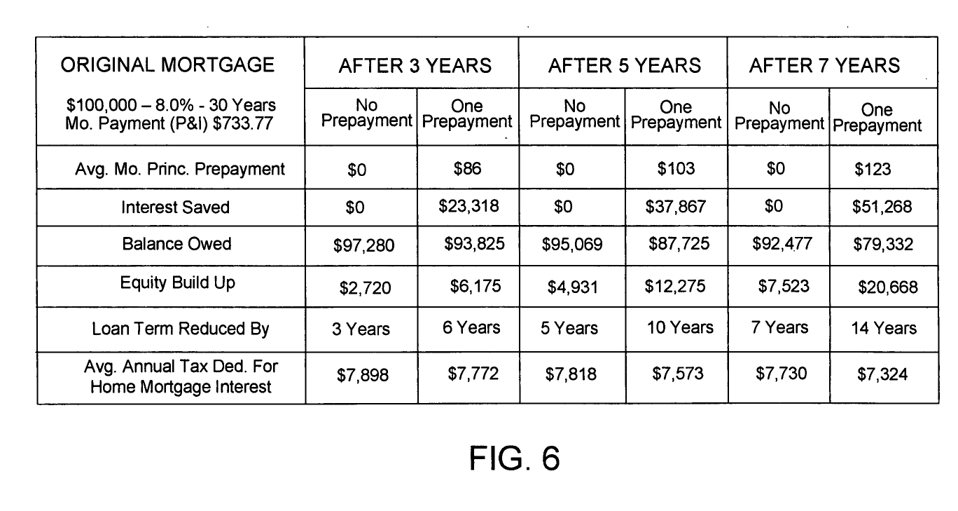

Referring now to FIG. 6 and using the same example $100,000, 8%, 30-year loan, the results where just one principal prepayment made each month in addition to the regular monthly payment can be shown.

As may be seen, the results can be dramatic. Thanks to compounding, small amounts of principal investment can produce significant benefits. Additional savings can be created if even greater amounts are prepaid, e.g. paying off several months or several years. Study of the loan amortization schedule in the Payment/Benefit Register can show how affordable and exciting the system can be.

Referring to the Payment/Benefit Register, the difference between the principal and interest portions of each installment can be seen. Each time the principal amount is prepaid, the interest expense associated with that specific payment is permanent eliminated, and the life of the loan reduced by one month. The “Totals This Page” amounts show how affordable it can be to prepay the total principal amount shown for that year and save the related total interest costs. This would also knock one full year off the life of the mortgage.

The Mortgage Miser system can be an invaluable tool in helping a mortgagee to get started and stay on course to achieve their financial goals with the comfort of knowing where they are going, that there are always in control, and they are doing it right.

Detecting And Resolving Errors

Verifying the lender's bookkeeping accuracy of payments is an essential step to managing a mortgage. All that is required is a comparison of the principal balance shown in the Payment/Benefit Register (after any payment has been made and received by the lender) with the lender's remaining loan balance to make sure that the respective records are in agreement. If a discrepancy does occur:
1. Records should be reviewed to make sure that all payments have been properly submitted in accordance with the terms of the loan agreement.
2. The lender or mortgage service company should be contacted and the matter should be reviewed with the customer service representative to attempt resolution. If no satisfactory resolution is reached, a copy of the loan payment history record should be obtained and compare with the Mortgage Miser records to identify any differences. The mortgagee can then meet with or provide the lender with a copy of the Mortgage Miser records.

3. If the lender or service company found to be responsible for any error, the mortgagee should obtain written notice of the details of the adjustment and confirmation that corrective action has been taken.

Adjustable Rate Mortgages

Unlike fixed rate mortgages, where the payment and amortization schedule is fixed for the life of the loan, adjustable rate mortgages are subject to rate and payment changes according to the terms of the promissory note. When a change does occur, the original payment and amortization schedule becomes obsolete. This will require a new Payment/Benefit Register schedule for the Mortgage Miser.

Common Myths And Other Questions.

After each required (regular) monthly payment has been made, the mortgagee is entitled to make additional prepayments of principal only. Most lenders allow the mortgagee to choose the amount of additional principal to submit. It is strongly recommend that the prepayment amounts follow the principal amounts of succeeding payments in the amortization schedule, e.g. as shown in the Mortgage Miser system. This will enable the mortgagee to track progress and to verify the lender's proper accounting.

The difference in the amount of tax deduction for mortgage interest, whether principal is prepaid or not, will be negligible, particularly in the early years of a mortgage because the interest attributed to required monthly payments will only be slightly lower each month. More importantly, it is far better to eliminate the expense entirely rather than to pay it and only recover a portion back through tax reduction.

Most monthly payment stubs and coupons today include a space for additional principal payments. However, the practice of sending irregular and/or random amounts require establishment of appropriate record keeping systems and recalculation of the entire loan after each such payment in order to keep records in proper order, and to be able to monitor the lender's proper application of payments. The Mortgage Miser system does all of this and provides the backup necessary to resolve lender bookkeeping errors, should they occur. This has become increasingly more important as mortgages are sold and resold to different service providers.

For record keeping purposes, prepayment of just the principal amounts of future payments shown in the amortization schedule enables the mortgagee to follow a pre-calculated program that eliminates the need for recalculation of the entire loan each time a payment is made. This allows the savings progress to be tracked and proper lender proper compliance to be easily monitored. It also provides greater flexibility, as the mortgagee's only obligation each month is to pay the minimum required monthly payment. A decision to prepay additional principal is made according to the mortgagee's plan and means. The mortgagee can pay none, one, or as many principal prepayments as desired without deviating from the system, always knowing the mortgage status automatically, without the need for any recalculation. Finally, this system motivates the mortgagee with a power to control and see the incredible savings that build from small affordable investments.

The Mortgage Miser system can be used with older (existing) mortgages as well as with new mortgages, as long as payments are current and the loan (promissory note) permits partial prepayment without penalty. Very few mortgages today have this restriction; however, if it does, the lender can be asked to waive this provision.

The Mortgage Miser system can be used with adjustable rate (ARM) mortgages, since the principles of loan amortization are the same as fixed rate mortgages (except that the rate and monthly payment will be adjusted according to the specific terms of the note). When an adjustment is warranted, the lender is required to send the mortgagee adequate advance notice of the change, the effective date, and specific terms of the change. According to the Mortgage Miser system, new Payment/Benefit Register forms can be prepared.

The money invested in prepaying your mortgage features a 100% guaranteed return on investment, which compounds at the rate of the note rate, with no commissions. Small monthly investments are permitted, and prepayment increases net worth by building home equity faster. It also shortens the term of a home mortgage and provides the peace of mind of a plan that will result in debt free home ownership.

To determine if a lender has made a mistake, the lender's record of the loan balance should be compared with your Mortgage Miser balance after any required monthly payment or optional principal prepayment has been made and posted to the account. If payments have been properly submitted, the two balances should agree. If the balances do not agree, this is a signal to contact the lender to find out why.

Writing a separate check for the principal prepayment and filling out a Lender Principal Prepayment Notice clearly separates the principal prepayment from the regular monthly payment, and thus reduces the chances of a servicing error. Additionally, it provides specific written instructions to the lender on application of the payment, and it provides the record support necessary to resolve an error, should one occur.

The Mortgage Miser system is especially helpful when attempting to refinance a high rate mortgage. Many homeowners are unable to refinance and take advantage of lower rates due to declining real estate values or other economic factors. As a result, they are trapped in the old mortgage and forced to continue paying at the higher rates. Although the Mortgage Miser system cannot reduce a note rate, it can reduce the amount of interest paid through principal prepayment. As a matter of fact, the interest savings is even more impressive with higher rate mortgages, thanks to the benefits of compounding.

A decision to require private mortgage insurance protection is controlled by the lender. Usually it is determined by the amount of equity that protects the loan, often called the loan-to-value ratio. Principal prepayment will reduce the loan balance more rapidly and thus increase the equity protection faster to eliminate the need for this costly protection. It should be noted, though, that other factors, e.g. loan payment performance, may also influence a lender's decision to require or discontinue this coverage.

A number of implementations have been described. Nevertheless, it will be understood that various modifications may be made without departing from the spirit and scope of the invention. Accordingly, other embodiments are within the scope of the following claims.

1. A method for mortgage prepayment and record-keeping, comprising:
making a required monthly mortgage payment,
selecting a prepayment amount,
making a prepayment in the selected amount, and
completing a register of payments and savings.

2. The method of claim 1 comprising the further step of:
selecting a prepayment amount equal to one or more present and/or future scheduled principal payments from an amortization schedule.

3. The method of claim 2 comprising the further step of:
selecting a prepayment amount equal to a sum of two or more present and/or future scheduled principal payments.

4. The method of claim 1, 2 or 3 comprising the further step of:
completing a loan prepayment note to accompany the prepayment.
